(19) United States
(12) Patent Application Publication
(10) Pub. No.: US 2025/0163840 A1
(43) Pub. Date: May 22, 2025

(54) GASKET FOR EXHAUST SYSTEM OF VEHICLE

(71) Applicants: Hyundai Motor Company, Seoul (KR); Kia Corporation, Seoul (KR)

(72) Inventors: Jongcheon Kim, Bucheon-si (KR); Bo Kyung Sa, Hwaseong-si (KR)

(21) Appl. No.: 18/817,845

(22) Filed: Aug. 28, 2024

(30) Foreign Application Priority Data
Nov. 16, 2023 (KR) 10-2023-0159328

(51) Int. Cl. F01N 13/18; C22C 38/00; C22C 38/02; C22C 38/04; C22C 38/40; F16J 15/08

(52) U.S. Cl. CPC F01N 13/1827; C22C 38/001; C22C 38/02; C22C 38/04; C22C 38/40; F16J 15/0806

(57) ABSTRACT

A gasket for an exhaust system of a vehicle, which can be formed by overlapping a first plate and a second plate having a central hole, in which the first plate can include a first bead inclined portion and a first bead flat portion extending parallel to the first plate from the first bead inclined portion to form the central hole, the second plate can include a second bead inclined portion and a second bead flat portion extending parallel to the second plate from the second bead inclined portion to form the central hole, the first plate and the second plate can have an asymmetric cross-section shape, the first plate and the second plate can include different materials, and the first bead flat portion and the second bead flat portion forming the central hole can overlap at least partially.

### CROSS-REFERENCE TO RELATED APPLICATIONS

This application claims the benefit of Korean Patent Application No. 10-2023-0159328, filed on Nov. 16, 2023, which application is hereby incorporated herein by reference.

### TECHNICAL FIELD

The present disclosure relates to a gasket for an exhaust system of a vehicle.

### BACKGROUND

Generally, exhaust gas discharged from an engine of a vehicle is transported through a main exhaust pipe and discharged into the atmosphere by reducing exhaust noise and exhaust pressure in a muffler. In this case, a gasket is installed between a coupling flange of the exhaust pipe and the muffler.

This gasket is interposed between the coupling flange of the exhaust pipe and the muffler and seals the leak of exhaust gas by fastening the flange through a fastening member such as a bolt and a nut. In this case, a fastening force of the fastening member acts strongly on a bead part of an area where the fastening member is fastened.

Therefore, because the fastening force of the fastening member does not apply evenly to the entire bead part, the sealing ability is good in an area close to the fastening area, but the leak prevention ability is significantly reduced in other areas and the flange corresponding to the fastening area is first deformed, so the amount of deformation of the flange increases in other areas of the fastening area.

To prevent this, the related art improves the sealing performance of the exhaust gas by increasing the number of beads in the gasket, that is, the number of metal plates. To improve the leak prevention function of the exhaust gas, a 4-layer bead type is usually used.

However, when using a multi-layer plate, the number of parts increases, the manufacturing method becomes complicated, and in particular, because the gasket is made of high alloy materials, the cost may increase.

Therefore, there is a demand for the development of a gasket that can reduce costs and has excellent sealing performance.

### SUMMARY

An embodiment of the present disclosure can provide a gasket for an exhaust system of a vehicle capable of reducing costs while maintaining sealing performance and durability.

According to an embodiment of the present disclosure, there is provided a gasket for an exhaust system of a vehicle, which is formed by overlapping a first plate and a second plate having a central hole, in which the first plate includes a first bead inclined portion and a first bead flat portion extending parallel to the first plate from the first bead inclined portion to form the central hole, the second plate includes a second bead inclined portion and a second bead flat portion extending parallel to the second plate from the second bead inclined portion to form the central hole, the first plate and the second plate have an asymmetric cross-section shape, the first plate and the second plate include different materials, and the first bead flat portion and the second bead flat portion forming the central hole overlap at least partially.

Using a gasket for an exhaust system of a vehicle according to an embodiment of the present disclosure, it can be possible to reduce manufacturing costs while maintaining excellent sealing performance and durability performance.

### BRIEF DESCRIPTION OF THE DRAWINGS

FIGS. 1 to 5 are diagrams illustrating a structure of a gasket for an exhaust system of a vehicle according to some embodiments of the present disclosure.

FIG. 6 is a diagram illustrating a structure of the conventional gasket for an exhaust system of a vehicle.

FIGS. 7 and 8 are diagrams illustrating a compression behavior of the gasket for an exhaust system of a vehicle according to some embodiments of the present disclosure.

FIGS. 9 to 11 are diagrams illustrating changes in hardness according to aging temperature for each material of a first plate and a second plate according to some embodiments of the present disclosure.

FIGS. 12 to 14 are diagrams illustrating an application part of a gasket for an exhaust system of a vehicle according to some embodiments of the present disclosure.

FIG. 15 is a diagram illustrating the structures of the conventional gasket for an exhaust system of a vehicle and the gasket for an exhaust system of a vehicle according to some embodiments of the present disclosure.

FIG. 16 is a diagram illustrating a fastening behavior of a general gasket.

FIGS. 17 and 18 are diagrams illustrating a fastening behavior of the conventional gasket.

FIG. 19 is a diagram illustrating a fastening behavior of the gasket for an exhaust system of a vehicle according to some embodiments of the present disclosure.

FIG. 20 is a diagram illustrating a structure of the conventional gasket for an exhaust system of a vehicle.

FIG. 21 is a diagram illustrating the structure of the gasket for an exhaust system of a vehicle according to some embodiments of the present disclosure.

FIG. 22 is a diagram illustrating standard tensile samples of an Example and a Comparative Example according to some embodiments of the present disclosure.

### DETAILED DESCRIPTION OF ILLUSTRATIVE EMBODIMENTS

Hereinafter, an example embodiment of the present disclosure is described in detail. However, it can be understood that this embodiment is provided as an example, and the present disclosure is not necessarily limited by this example embodiment, but can be defined by the scopes of claims.

Throughout the present specification, when any member is referred to as being positioned “on” another member, it can include not only a case in which any member and another member are in contact with each other, but also a case in which some other member is interposed between any member and another member.

In the present disclosure, unless explicitly described to the contrary, “comprising” any components can be understood to imply the inclusion of other components rather than the exclusion of any other components.

According to an embodiment of the present disclosure, a gasket 100 for an exhaust system of a vehicle, which can be formed by overlapping a first plate 10 and a second plate 20 having a central hole, in which the first plate 10 can include a first bead inclined portion 12 and a first bead flat portion 11 extending parallel to the first plate 10 from the first bead inclined portion 12 to form the central hole, the second plate 20 can include a second bead inclined portion 22 and a second bead flat portion 21 extending parallel to the second plate 20 from the second bead inclined portion 22 to form the central hole, the first plate 10 and the second plate 20 have an asymmetric cross-section shape, the first plate 10 and the second plate 20 include different materials, and the first bead flat portion 11 and the second bead flat portion 21 forming the central hole overlap at least partially.

Because the gasket 100 for an exhaust system of a vehicle according to an embodiment of the present disclosure includes the asymmetric first plate 10 and second plate 20 having different shapes and materials, it can have the advantage of excellent sealing performance and durability performance while reducing costs.

The first plate 10 can include the first bead inclined portion 12 and the first bead flat portion 11 extending parallel to the first plate 10 from the first bead inclined portion 12 to form the central hole.

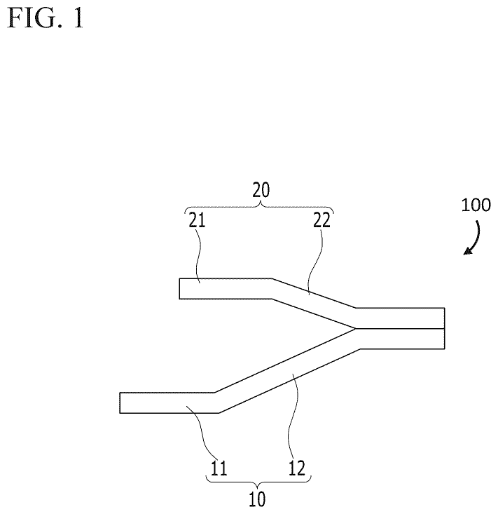

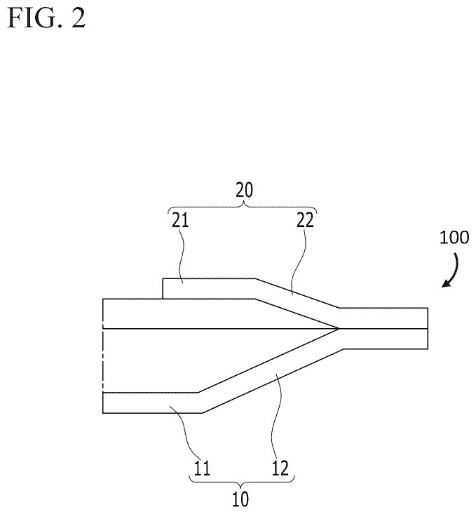

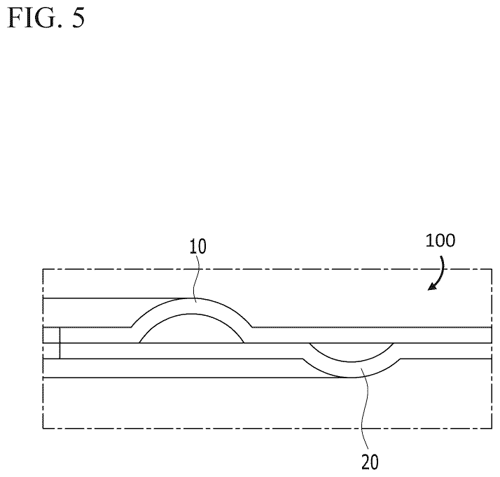

Referring to FIGS. 1 to 5, in the present disclosure, the “inclined portion” may refer to a state that is inclined at a selected or predetermined angle, or may refer to a state that is bent upward or downward.

The second plate 20 can include the second bead inclined portion 22 and the second bead flat portion 21 extending parallel to the second plate 20 from the second bead inclined portion 22 to form the central hole.

The plates 10 and 20 may be provided with coupling parts each having coupling holes on both sides of the central hole, and a length of the bead inclined portion (12, 22) may be formed to vary rather than being constant around the entire circumference of the central hole.

However, the first plate 10 and the second plate 20 can be made of different materials and can have an asymmetric cross-section structure.

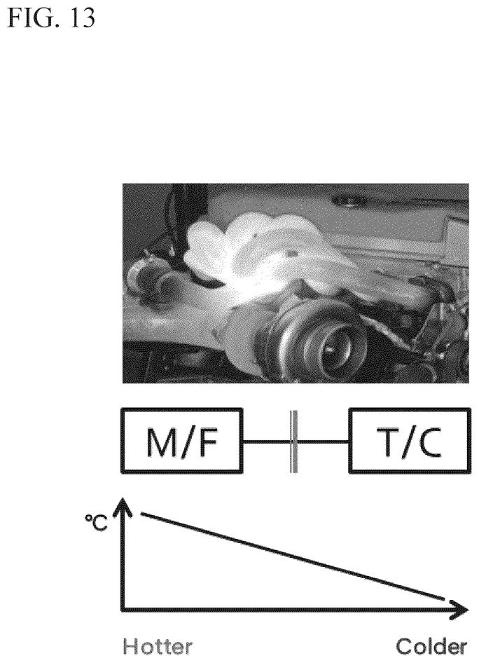

One surface of the gasket 100 for an exhaust system of a vehicle may be positioned on a system side with a relatively high temperature, and the opposite surface may be positioned on a system side with a relatively low temperature (see, e.g., FIG. 13).

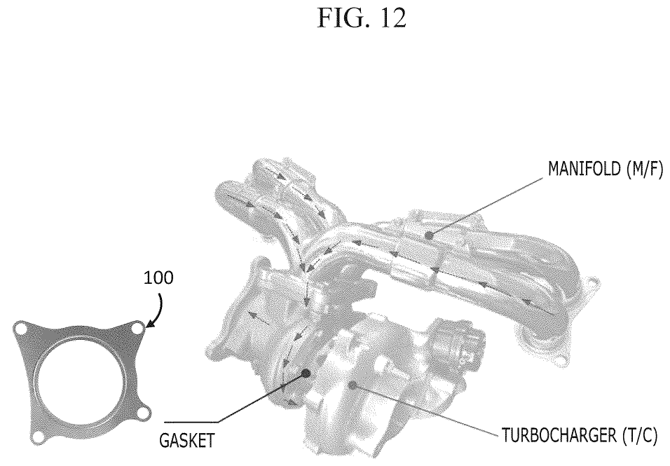

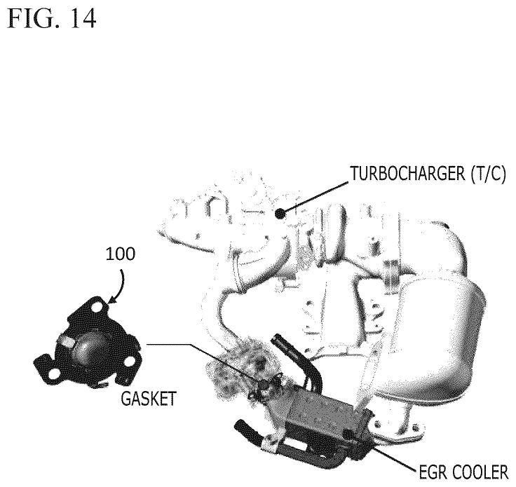

FIG. 12 is a diagram illustrating the gasket 100 applied to a turbocharger, for example. FIG. 14 is a diagram illustrating the gasket 100 applied to an EGR cooler, for example.

Thus, the gasket 100 for an exhaust system of a vehicle may be applied to parts that exhibit temperature distribution, such as a turbocharger.

Therefore, in an embodiment of the present disclosure, by applying a relatively higher grade material to the plate positioned on the system where the temperature is relatively higher, and applying a relatively lower grade material to the plate provided in a portion positioned on the system where the temperature is relatively lower, a thermal stress distribution can be considered and costs can be reduced. FIG. 13 is a diagram illustrating a temperature distribution of a manifold (M/F) and a turbocharger (T/C).

However, when the first plate 10 and the second plate 20 are made of different materials and have a symmetrical structure, there can be a problem in that the sealing performance can be reduced due to the structural strength asymmetry. Therefore, in an embodiment of the present disclosure, the first plate 10 and the second plate 20 can be formed into an asymmetric structure to solve the above-described problem.

The gasket 100 for an exhaust system of a vehicle according to an embodiment of the present disclosure can be made of different materials and can include an asymmetric plate, so material costs may be reduced and the excellent structure and sealing performance of equal or higher level may be obtained, compared to the case of using the conventional multi-layer plate.

In an embodiment of the present disclosure, one of the first plate 10 or the second plate 20 can include a first material, and the first material may include 0.1 to 0.15 parts by weight of carbon, 0.30 to 0.75 parts by weight of silicon, 0.50 to 2.0 parts by weight of manganese, 0.01 to 0.045 parts by weight of phosphorus, 0.0001 to 0.03 parts by weight of sulfur, and 16.0 to 18.0 parts by weight of chromium, 6.0 to 8.0 parts by weight of nickel, and the balance of iron based on a total 100 parts by weight of the plate, for example.

Specifically, one of the first plate 10 or the second plate 20 may be formed of SUS301 material.

In an embodiment of the present disclosure, the other of the first plate 10 or the second plate 20 can include a second material, and the second material may include 0.08 to 0.1 parts by weight of carbon, 0.15 to 0.40 parts by weight of silicon, 2.0 to 4.0 parts by weight of manganese, 0 to 0.03 parts by weight of phosphorus, 17.0 to 19.0 parts by weight of chromium, 3.0 to 4.0 parts by weight of nickel, 0.2 to 0.3 parts by weight of nitrogen, and the balance of iron based on a total 100 parts by weight of the plate, for example.

The second material may further include nitrogen compared to the first material. The nitrogen can be an austenite stabilizing element and may improve high temperature fatigue life.

In addition, the second material may include a greater amount of manganese than the first material. The manganese can serve to increase solubility of nitrogen in a matrix structure.

In addition, when the carbon satisfies the above range, bursting during bead molding may be suppressed, which can be preferable.

Thus, the second material may increase durability performance through the addition of the nitrogen element for high temperature strengthening even if it has the reduced content of chromium and nickel that are relatively expensive compared to the materials used for the plate conventionally and does not necessarily include molybdenum.

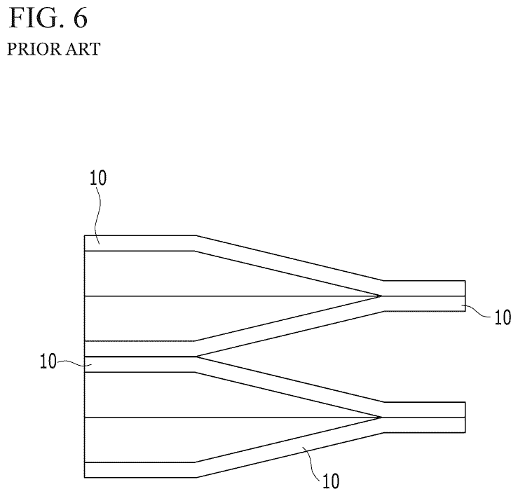

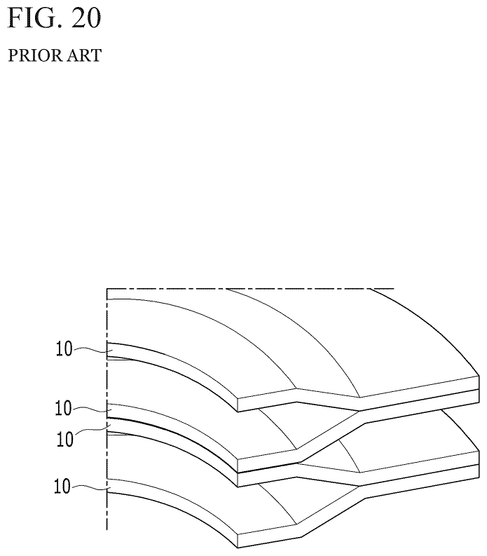

Conventionally, SUS301 [18% Cr-8% Ni-2% Mn] and DSN9 [25% Cr-10% Ni-6% Mn-2% Mo] (Japanese Daiso Steel, Osteitis-based high-strength gasket SUS material), which are high-alloy materials, were overlapped in the high temperature system gasket part in 4 layers or more (see, e.g., FIGS. 6 and 20).

However, the SUS301 material has a slightly lower cost than the DSN9 material, but has the problem of low heat resistance, and the DSN9 material has excellent heat resistance, but has the problem of being very expensive.

However, the gasket 100 for an exhaust system of a vehicle according to an embodiment of the present disclosure may use an intermediate grade material, specifically the first material, of the SUS301 material and the DSN9 material described above, so it can be possible to reduce costs compared to using the DSN9 material and increase heat resistance compared to using the SUS301 material.

Specifically, the second material can be applied to the plate located in the system with the relatively higher temperature among the first plate 10 and the second plate 20.

The first material can be applied to the plate located in the system with the relatively lower temperature among the first plate 10 and the second plate 20.

The first plate 10 and the second plate 20 can have an asymmetric structure.

In an embodiment of the present disclosure, the first bead inclined portion 12 and the second bead inclined portion 22 may have different lengths (see, e.g., FIGS. 1 to 4).

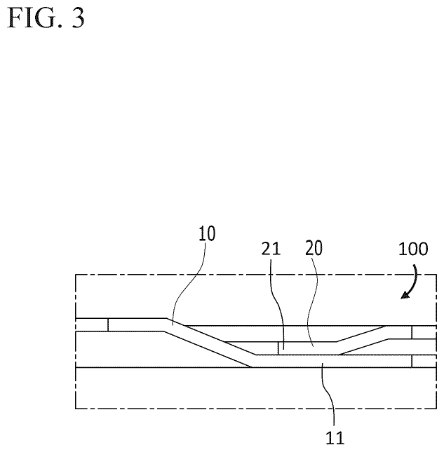

In an embodiment of the present disclosure, the first bead flat portion 11 and the second flat portion 21 may have different lengths (see, e.g., FIG. 3).

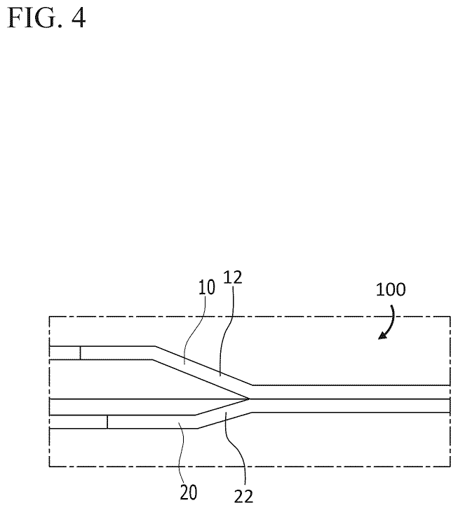

In an embodiment of the present disclosure, the first bead inclined portion 12 and the second bead inclined portion 22 may have different inclination angles (see, e.g., FIG. 4).

Thus, the first plate 10 and the second plate 20 may each include the bead inclined portions 12 and 22 having different lengths or inclination angles, thereby exhibiting an asymmetric structure.

Alternatively, the first plate 10 and the second plate 20 may each include the flat portions 11 and 21 having different lengths, thereby exhibiting an asymmetric structure.

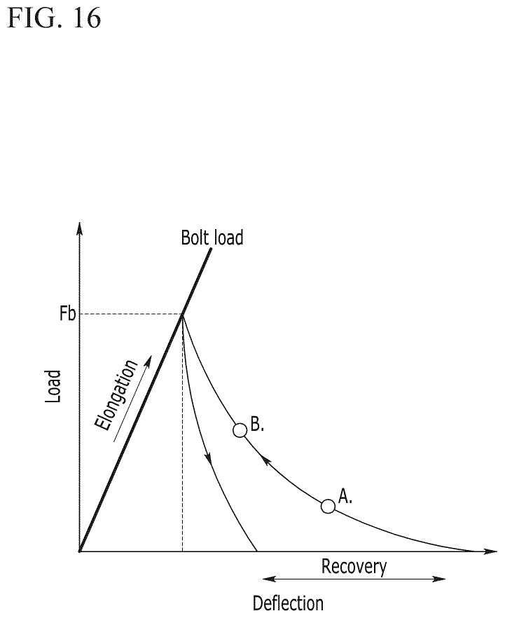

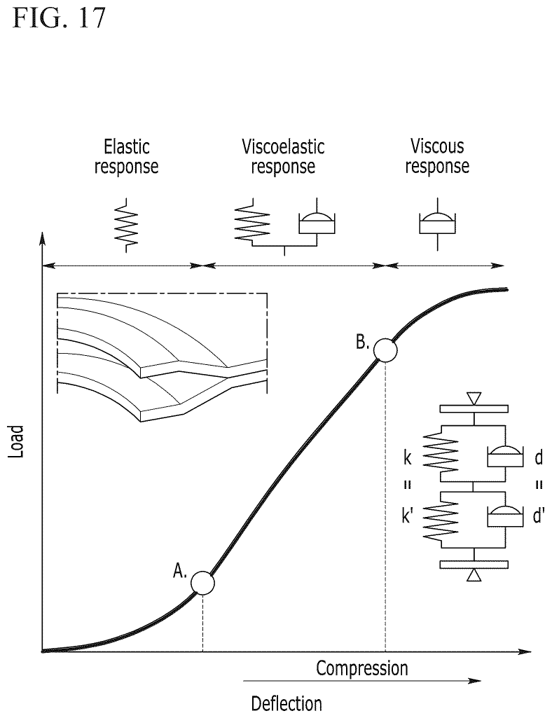

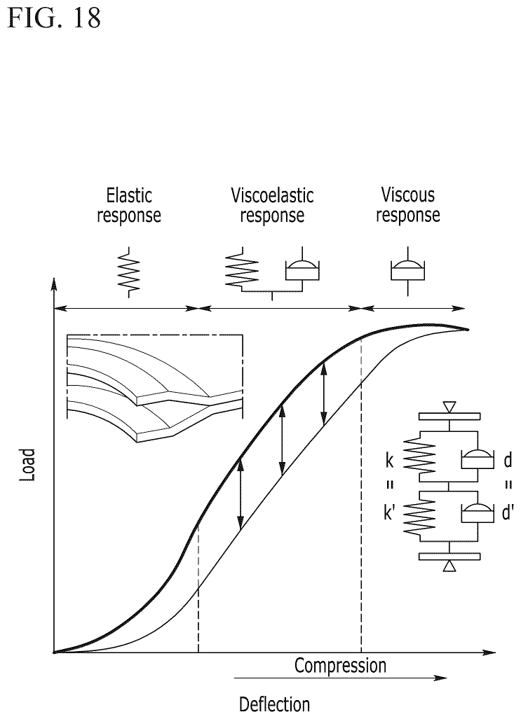

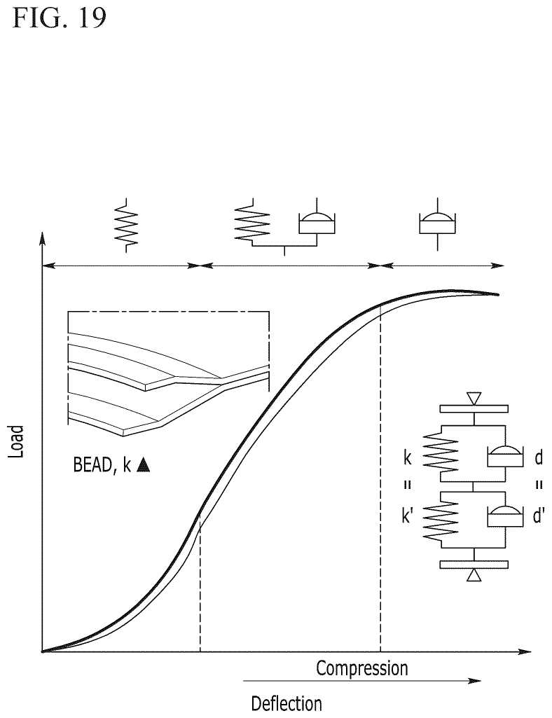

FIG. 16 illustrates a fastening behavior of a general gasket, and the system may secure the desired sealing performance at point Fb. The behavior of the gasket can be composed of three stages: elasticity→viscoelasticity→viscosity. FIG. 17 illustrates a fastening behavior when using the same material. When the same material is used as illustrated in FIG. 17, the applied load on the gasket layer is the same, so the target sealing performance may be expected. FIG. 18 illustrates the fastening behavior when using different materials. To apply different materials with different strengths as illustrated in FIG. 18, to overcome the asymmetry caused by a difference in material strength, this may be corrected using bead shape asymmetry, which is a design element, as illustrated in FIG. 19.

Without being limited by theory, for example, when the strength difference between the first plate 10 and the second plate 20 is about 20%, appropriate symmetry may be secured at a level of 1.5 to 2 times a bead width L. In this case, the bead width may be calculated using Equations 1 and 2 below.

$$k = P / δ \qquad [ Equation 1 ]$$

In Equation 1, k denotes a spring constant, P denotes a load (unit: kgf), and δ denotes a deflection (unit: mm).

$$δ = \frac{{PL}^{3}}{3 EI} \qquad [ Equation 2 ]$$

In Equation 2, δ and P are as defined in Equation 1 above, and L denotes the bead width, E denotes Young's modulus, and I denotes the moment of inertia.

In an embodiment of the present disclosure, one of the first plate 10 or the second plate 20 may include a half bead part.

In an embodiment of the present disclosure, one of the first plate 10 or the second plate 20 may include a full bead part.

Thus, the gasket 100 for an exhaust system of a vehicle according to an embodiment of the present disclosure can be applied to both half-bead and full-bead forms.

The central hole may be an exhaust passage through which the exhaust gas passes, and fastening holes may be formed on both sides of the central hole with the central hole therebetween, and a fastening portion may be formed between the central hole and the fastening hole, but is not necessarily limited thereto.

The first plate 10 may be provided with a stopper on an upper surface corresponding to the fastening portion, but is not necessarily limited thereto.

The gasket 100 for an exhaust system of a vehicle may be further equipped with additional components commonly provided in the art as long as it does not impair the purpose of an embodiment of the present disclosure, but is not necessarily limited thereto.

The gasket 100 for an exhaust system of a vehicle according to an embodiment of the present disclosure may be usefully applied as a cylinder head gasket, a manifold gasket, a turbocharger gasket, or an EGR cooler gasket, for example.

The following examples illustrate embodiments of the present disclosure in more detail. However, the following Examples are only example embodiments of the present disclosure, and the present disclosure is not necessarily limited to the following Examples.

### Example

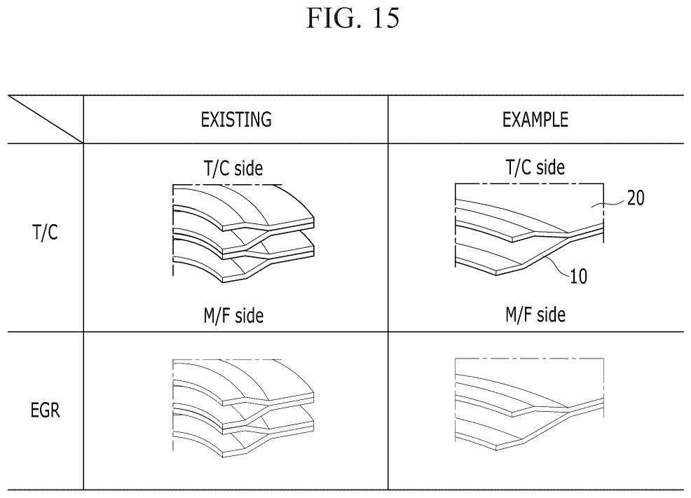

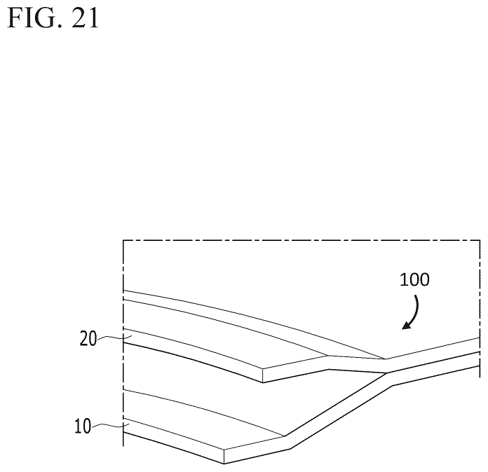

A gasket (EGR gasket, half bead) for an exhaust system of a vehicle of the same type as illustrated in FIG. 4 (see, e.g., FIGS. 15 and 21) was manufactured.

In this case, a first plate (first material) and a second plate (second material) were each manufactured using materials according to the following composition (total 100 parts by weight).

TABLE 1

| | Chemical component (parts by weight) | | | | | | | | | |
|---|---|---|---|---|---|---|---|---|---|---|
| | C | Si | Mn | P | S | Cr | Ni | Mo | N | F |
| First plate | 0.11 | 0.65 | 0.88 | 0.03 | 0.0012 | 17.19 | 6.67 | — | 0.11 | remainder |
| (SUS301H) | | | | | | | | | | |
| Second plate | 0.08 | 0.37 | 3.00 | 0.03 | 0.00 | 18.00 | 3.50 | 0.25 | 0.08 | remainder |

### Comparative Example

A conventional gasket for an exhaust system of a vehicle composed of four symmetrical SUS301H material plates was used (see, e.g., FIGS. 15 and 20).

### Experimental Example

### (1) Mechanical Properties of First and Second Materials

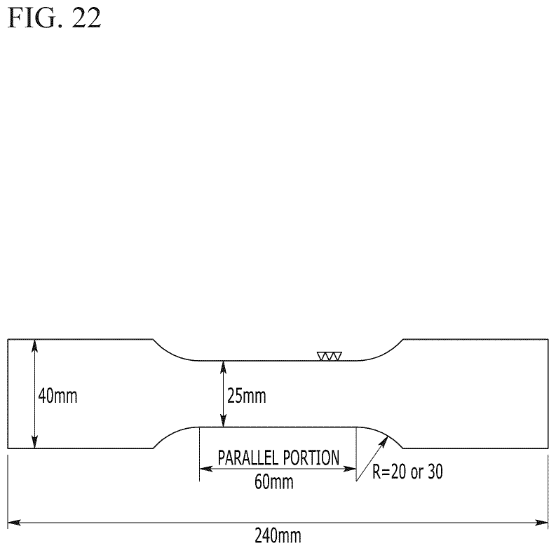

To determine a difference in mechanical properties between a first material M1 and a second material M2, a standard tensile sample illustrated in FIG. 22 was manufactured, and then mechanical properties were measured using a universal tensile tester (MTS), and the results are shown in Table 2 below.

TABLE 2

| | Tensile | Elongation | Hardness |
|---|---|---|---|
| | strength (MPa) | (%) | (Hv) |
| First material | 1500 | 9.8 | 480 |
| (SUS301H) | | | |
| Second material | 1770 | 3.0 | 515 |
| | 18% ▴ | 69% ▾ | 7%▴ |

### (2) Heat Resistance Characteristics of First and Second Materials

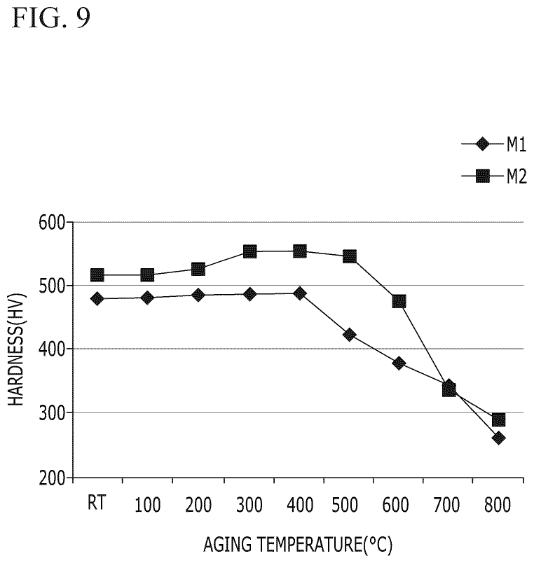

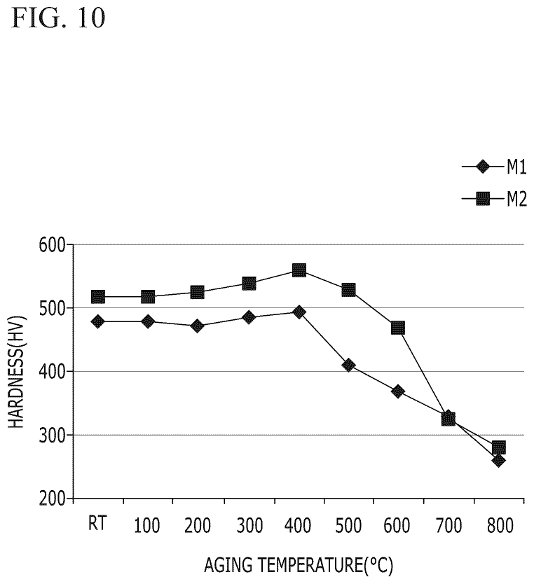

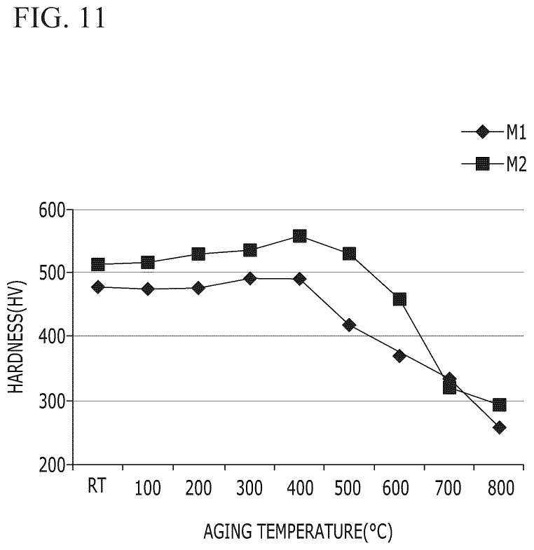

Heat resistance properties of the first and second materials were measured and the results are shown in Table 3 below and FIGS. 9 to 11.

TABLE 3

| | Change in hardness(Hv) | | | | | |
|---|---|---|---|---|---|---|
| | 1 hr | | 5 hr | | 10 hr | |
| Aging | first | second | first | second | first | second |
| temperature | material M1 | material M2 | material M1 | material M2 | material M1 | material M2 |
| R.T | 478 | 514 | 478 | 514 | 478 | 514 |
| 100° C. | 481 | 514 | 481 | 518 | 474 | 517 |
| 200° C. | 484 | 523 | 472 | 524 | 476 | 529 |
| 300° C. | 484 | 552 | 485 | 538 | 489 | 534 |
| 400° C. | 487 | 554 | 493 | 557 | 490 | 556 |
| 500° C. | 423 | 545 | 410 | 530 | 420 | 530 |
| 600° C. | 380 | 474 | 367 | 470 | 370 | 460 |
| 700° C. | 344 | 336 | 331 | 325 | 336 | 322 |
| 800° C. | 261 | 292 | 261 | 281 | 258 | 294 |

### (3) Compression Behavior Characteristics of First and Second Materials

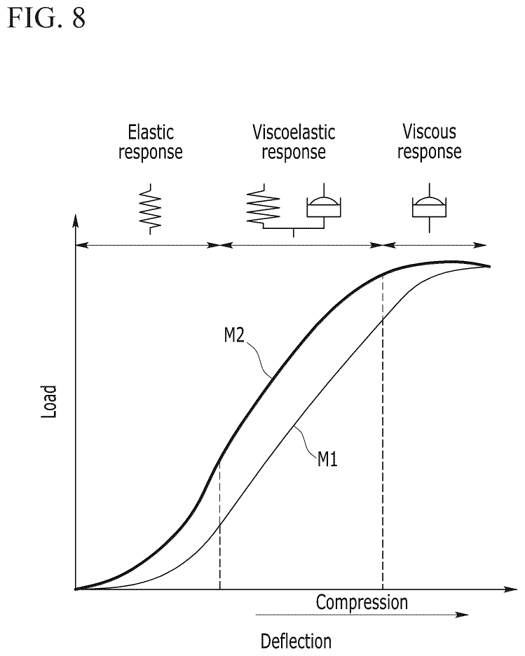

Compression behavior characteristics of the first and second materials were measured and the results are illustrated in FIG. 8.

### (4) Compression Behavior Characteristics of Gasket of Example

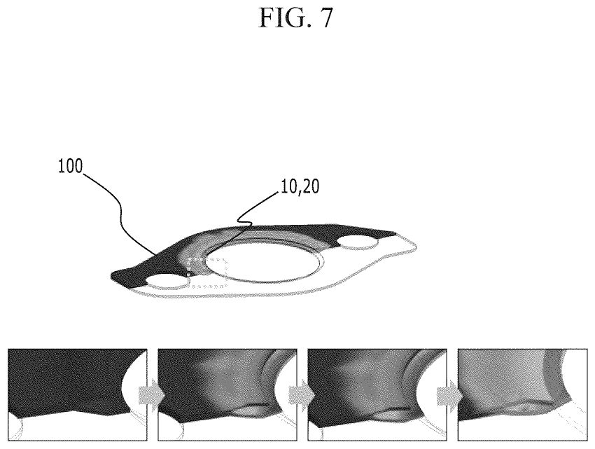

Compression behavior characteristics of a gasket manufactured according to Example were observed and the results are illustrated in FIG. 7.

### (5) Heat Aging Evaluation

Heat aging evaluation results (surface pressure measurement, 400/500/600° C.) of a gasket according to Example and Comparative Example are shown in Table 4 below. Specifically, the surface pressure was measured after fastening a bolt to upper/lower jigs with a fastening torque of 5 kgf and exposing the upper/lower jigs to a furnace for a certain period of time.

Referring to Tables 2 to 4 and FIGS. 7 to 11, although the gasket according to an embodiment of the present disclosure uses a 2-layer first plate and a second plate, it could be seen that it shows excellent performance equivalent to or more than Comparative Example using the existing 4-layer plate.

The present disclosure is not necessarily limited to the example embodiments, but may be manufactured in a variety of different forms, and an embodiment of the present disclosure may be manufactured in a variety of different forms, and those of ordinary skill in the art to which the present disclosure pertains can understand that an embodiment of the present disclosure may be implemented in other specific forms without changing the technical spirit or essential features of the present disclosure. Therefore, it can be understood that the above-mentioned example embodiments are illustrative examples but are not necessarily limited thereto.

What is claimed is:

1. A gasket for an exhaust system of a vehicle, comprising:
a first plate; and
a second plate, wherein the first plate overlaps the second plate,
wherein the first plate and the second plate have a central hole,
wherein the first plate includes a first bead inclined portion,
wherein the first plate includes a first bead flat portion extending parallel to the first plate from the first bead inclined portion to form the central hole,
wherein the second plate includes a second bead inclined portion,
wherein the second plate includes a second bead flat portion extending parallel to the second plate from the second bead inclined portion to form the central hole,
wherein the first plate and the second plate have an asymmetric cross-section shape,
wherein the first plate and the second plate include different materials, and
wherein the first bead flat portion and the second bead flat portion forming the central hole overlap at least partially.

2. The gasket of claim 1, wherein the first plate or the second plate includes a first material, and wherein the first material includes 0.1 to 0.15 parts by weight of carbon, 0.30 to 0.75 parts by weight of silicon, 0.50 to 2.0 parts by weight of manganese, 0.01 to 0.045 parts by weight of phosphorus, 0.0001 to 0.03 parts by weight of sulfur, and 16.0 to 18.0 parts by weight of chromium, 6.0 to 8.0 parts by weight of nickel, and a first balance of iron based on a first total 100 parts by weight of the first plate or the second plate.

3. The gasket of claim 2, wherein the first plate includes the first material and the second plate includes a second material or wherein the second plate includes the first material and the first plate includes the second material, and
wherein the second material includes 0.08 to 0.1 parts by weight of carbon, 0.15 to 0.40 parts by weight of silicon, 2.0 to 4.0 parts by weight of manganese, 0 to 0.03 parts by weight of phosphorus, 17.0 to 19.0 parts by weight of chromium, 3.0 to 4.0 parts by weight of nickel, 0.2 to 0.3 parts by weight of nitrogen, and a second balance of iron based on a second total 100 parts by weight of the first plate or the second plate.

4. The gasket of claim 1, wherein the first bead inclined portion and the second bead inclined portion have different lengths.

5. The gasket of claim 1, wherein the first bead flat portion and the second bead flat portion have different lengths.

6. The gasket of claim 1, wherein the first bead inclined portion and the second bead inclined portion have different inclination angles.

7. The gasket of claim 1, wherein the first plate includes a half bead part or the second plate includes a half bead part.

8. The gasket of claim 1, wherein the first plate includes a full bead part or the second plate includes a full bead part.

9. A gasket comprising:
a first plate at least partially outlining a hole, the first plate including a first first-plate flat portion, a second first-plate flat portion, and a first first-plate inclined portion, wherein the first first-plate inclined portion extends from the first first-plate flat portion at a first angle, and wherein the second first-plate flat portion extends from the first first-plate inclined portion at the first angle such that the first first-plate flat portion is parallel with the second first-plate flat portion; and
a second plate at least partially outlining the hole, the second plate including a first second-plate flat portion, a second second-plate flat portion, and a first second-plate inclined portion, wherein the first second-plate inclined portion extends from the first second-plate flat portion at a second angle, wherein the second second-plate flat portion extends from the first second-plate inclined portion at the second angle such that the first second-plate flat portion is parallel with the second second-plate flat portion, wherein the first first-plate flat portion overlaps with the first second-plate flat portion, wherein a first total length of the first plate is different than a second total length of the second plate.

10. The gasket of claim 9, wherein the second first-plate flat portion and the second second-plate flat portion have different lengths.

11. The gasket of claim 9, wherein the first first-plate inclined portion and the first second-plate inclined portion have different lengths.

12. The gasket of claim 9, wherein the first angle is different than the second angle.

13. The gasket of claim 9, wherein the first plate includes a first material, wherein the second plate includes a second material, and wherein the first material differs from the second material.

14. The gasket of claim 13, wherein the first material includes 0.1 to 0.15 parts by weight of carbon, 0.30 to 0.75 parts by weight of silicon, 0.50 to 2.0 parts by weight of manganese, 0.01 to 0.045 parts by weight of phosphorus, 0.0001 to 0.03 parts by weight of sulfur, and 16.0 to 18.0 parts by weight of chromium, 6.0 to 8.0 parts by weight of nickel, and a first balance of iron based on a first total 100 parts by weight of the first plate, and
wherein the second material includes 0.08 to 0.1 parts by weight of carbon, 0.15 to 0.40 parts by weight of silicon, 2.0 to 4.0 parts by weight of manganese, 0 to 0.03 parts by weight of phosphorus, 17.0 to 19.0 parts by weight of chromium, 3.0 to 4.0 parts by weight of nickel, 0.2 to 0.3 parts by weight of nitrogen, and a second balance of iron based on a second total 100 parts by weight of the second plate.

15. A gasket comprising:
a first plate at least partially outlining a hole, the first plate including a first first-plate flat portion, a second first-plate flat portion, and a first first-plate inclined portion, wherein the first first-plate inclined portion extends from the first first-plate flat portion at a first angle, and wherein the second first-plate flat portion extends from the first first-plate inclined portion at the first angle such that the first first-plate flat portion is parallel with the second first-plate flat portion; and
a second plate at least partially outlining the hole, the second plate including a first second-plate flat portion, a second second-plate flat portion, and a first second-plate inclined portion, wherein the first second-plate inclined portion extends from the first second-plate flat portion at a second angle, wherein the second second-plate flat portion extends from the first second-plate inclined portion at the second angle such that the first second-plate flat portion is parallel with the second second-plate flat portion, wherein the first first-plate flat portion overlaps with the first second-plate flat portion, wherein the first plate includes a first material, wherein the second plate includes a second material, and wherein the first material differs from the second material.

16. The gasket of claim 15, wherein the first material includes 0.1 to 0.15 parts by weight of carbon, 0.30 to 0.75 parts by weight of silicon, 0.50 to 2.0 parts by weight of manganese, 0.01 to 0.045 parts by weight of phosphorus, 0.0001 to 0.03 parts by weight of sulfur, and 16.0 to 18.0 parts by weight of chromium, 6.0 to 8.0 parts by weight of nickel, and a first balance of iron based on a first total 100 parts by weight of the first plate.

17. The gasket of claim 15, wherein the second material includes 0.08 to 0.1 parts by weight of carbon, 0.15 to 0.40 parts by weight of silicon, 2.0 to 4.0 parts by weight of manganese, 0 to 0.03 parts by weight of phosphorus, 17.0 to 19.0 parts by weight of chromium, 3.0 to 4.0 parts by weight of nickel, 0.2 to 0.3 parts by weight of nitrogen, and a second balance of iron based on a second total 100 parts by weight of the second plate.

18. The gasket of claim 15, wherein the second first-plate flat portion and the second second-plate flat portion have different lengths.

19. The gasket of claim 15, wherein the first first-plate inclined portion and the first second-plate inclined portion have different lengths.

20. The gasket of claim 15, wherein the first angle is different than the second angle.
